(19) United States
(12) Patent Application Publication
(10) Pub. No.: US 2006/0066772 A1
(43) Pub. Date: Mar. 30, 2006

(54) Display apparatus and information terminal

(75) Inventors: Hiroyuki Takahashi, Kanagawa-ken (JP); Noriyasu Kawamura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/235,306

(22) Filed: Sep. 27, 2005

(30) Foreign Application Priority Data
Sep. 27, 2004 (JP) 2004-279914

(51) Int. Cl. G02F 1/1333

(52) U.S. Cl. 349/60

(57) ABSTRACT

A display apparatus including: a display unit configured to display an image; a shock absorbing elastic body configured to contact the display unit; a press member configured to press against the elastic body; and a catch member configured to secure the press member; wherein the elastic body absorbs shock transferred from the catch member to the press member.

### CROSS-REFERENCE TO RELATED APPLICATIONS

This application is based upon and claims the benefit of priority under 35 U.S.C. § 119 from prior Japanese Patent Application 2004-279914 filed on Sep. 27, 2004; the entire contents of which are incorporated by reference herein.

### BACKGROUND OF THE INVENTION

1. Field of the Invention

Exemplary embodiments of the present invention relate to a display apparatus and an information terminal with a display device, such as a Liquid Crystal Display (LCD).

2. Description of the Background

The use of an information terminal with a LCD, such as a notebook PC, has become more and more common these days.

However, in connection with the increase in use, dropping of the information terminal has also increased. As a result of dropping the terminal, the LCD of the information terminal can become damaged.

In an effort to reduce damage to the LCD, others have inserted some shock absorbing material between a case and the LCD of the information terminal. In an example of an information terminal having a case and a LCD, a hinge is connected by screws to the LCD unit and a protection base. This technique prevents directly transmitting shock from a main body to the LCD. However, this technique is insufficient because the screw connects the case and the LCD rigidly. Accordingly, shock is transmitted to the LCD through the screw (see, e.g., JP-A-2004-4721).

The related art also includes forming a shock absorbing material like a frame around the LCD. That is, the inner size of the shock absorbing material is designed smaller than an outer size of the LCD, and the LCD is fitted into the inner side of the shock absorbing material. This technique prevents transmission of a shock from the main body to the LCD well. According to this technique, the shock absorbing material fills a gap between the case and the LCD, and strongly cramps the LCD to the case. However, much effort is required to press the shock absorbing material into the gap between the LCD and the case making assembly difficult (see, e.g., JP-A-2001-183634).

### BRIEF SUMMARY OF THE INVENTION

Accordingly, an object of the present invention is to provide a display unit that can survive being dropped and can be easily assembled.

According to an exemplary embodiment, one aspect of the invention is a display apparatus including a display unit configured to display an image; a shock absorbing elastic body configured to contact the display unit; a press member configured to press against the elastic body; and a catch member configured to secure the press member. The elastic body absorbs shock transferred from the catch member to the press member.

### BRIEF DESCRIPTION OF THE SEVERAL VIEWS OF THE DRAWINGS

The invention and attendant advantages therefore are best understood from the following description of the non-limiting embodiments when read in connection with the accompanying Figures, wherein:

FIG. 1 illustrates a perspective view of a notebook PC;

FIG. 2 illustrates a sectional view of a display section in a plane parallel to a display face of a LCD unit according to a first exemplary embodiment;

FIG. 3 illustrates a sectional view of a section near a screw hole and a screw according to a first exemplary embodiment;

FIG. 4 illustrates a sectional view of a display section in a plane parallel to a left side face of a LCD unit according to a first exemplary embodiment;

FIG. 5 illustrates a sectional view of a display section in a plane parallel to a display face of a LCD unit, without a roll off, according to a first exemplary embodiment;

FIG. 6 illustrates a sectional view of a section near a screw hole and a screw, without a roll off, according to a first exemplary embodiment;

FIG. 7 illustrates a sectional view of a display section in a plane parallel to a side face of a LCD section, without a roll off, according to a first exemplary embodiment;

FIG. 8 illustrates a sectional view of a display section in a plane parallel to a display face of a LCD unit according to a second exemplary embodiment;

FIG. 9 illustrates a sectional view of a section near a screw hole and a screw according to a second exemplary embodiment;

FIG. 10 illustrates a sectional view of a display section in a plane parallel to a display face of a LCD unit according to a third exemplary embodiment;

FIG. 11 illustrates a sectional view of a display section in a plane parallel to a side face of a LCD unit according to a third exemplary embodiment;

FIG. 12 illustrates a sectional view of a display section in a plane parallel to a display face of a LCD unit according to a fourth exemplary embodiment;

FIG. 13 illustrates a sectional view of a display section in a plane parallel to a display face of a LCD unit according to a fifth exemplary embodiment;

FIG. 14 illustrates a sectional view of a display section in a plane parallel to a display face of a LCD unit according to a sixth exemplary embodiment;

FIG. 15 illustrates a sectional back view of a display section in a plane parallel to a display face of a LCD unit according to a sixth exemplary embodiment;

FIG. 16 illustrates a sectional view of a display section in a plane parallel to a side face of a LCD unit according to a sixth exemplary embodiment;

FIG. 17 illustrates a perspective sectional view of the display section according to a seventh exemplary embodiment;

FIG. 18 illustrates a sectional view of a display section in a plane parallel to a side face of a LCD unit according to a seventh exemplary embodiment;

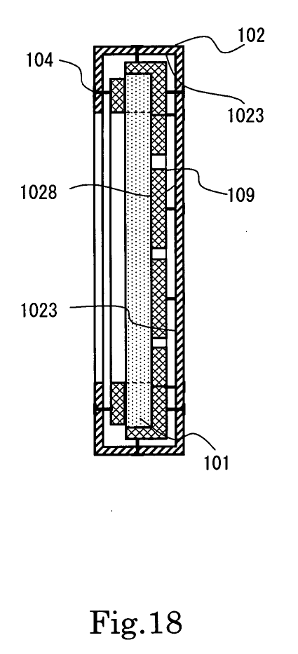

FIG. 19 illustrates a perspective sectional view of the display section according to an eighth exemplary embodiment;

FIG. 20 illustrates a sectional view of a display section in a plane parallel to a display face of a LCD unit according to a ninth exemplary embodiment;

FIG. 21 illustrates a sectional view of a section near a screw hole and a screw according to a ninth exemplary embodiment;

FIG. 22 illustrates a sectional view of a display section in a plane parallel to a display face of a LCD unit according to a tenth exemplary embodiment;

FIG. 23 illustrates a sectional view of a section near a screw hole and a screw according to a tenth exemplary embodiment;

FIG. 24 illustrates a sectional view of a display section, before pressing a side rubber, in a plane parallel to a side face of a LCD unit according to an eleventh exemplary embodiment;

FIG. 25 illustrates a sectional view of a display section, in which a pad presses a side rubber, in a plane parallel to a side face of a LCD unit according to an eleventh exemplary embodiment;

FIG. 26 illustrates a sectional view of a display section in a plane parallel to a display face of a LCD unit according to a twelfth exemplary embodiment;

FIG. 27 illustrates a exploded view of a display according to a twelfth exemplary embodiment; and

FIG. 28 illustrates a sectional view of a section near a screw hole of a screw support member and a screw.

### DETAILED DESCRIPTION OF THE INVENTION

Referring now to the Figures in which like reference numerals designate identical or corresponding parts throughout the several views.

### First Exemplary Embodiment

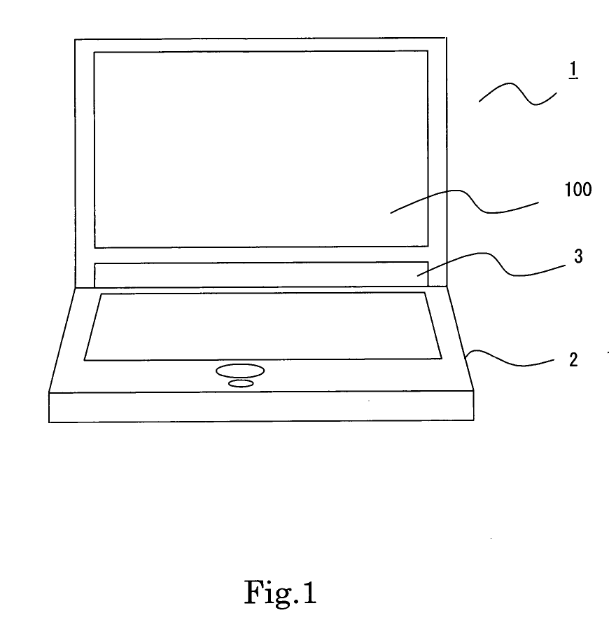

FIG. 1 illustrates a perspective view of an example of a first non-limiting embodiment of a notebook PC 1 according to the invention.

The notebook PC 1 includes a main body 2, a hinge 3, and the display section 100 having a LCD unit 101. The main body 2 has a keyboard, a click button, etc.

The main body 2 processes data inputted by a user using the keyboard and the click button, and outputs image data for presenting to the user according to the processing.

The hinge 3 supports the display section 100 turnably to the main body 2. The display section 100 displays an image according to the image data from the main body 2.

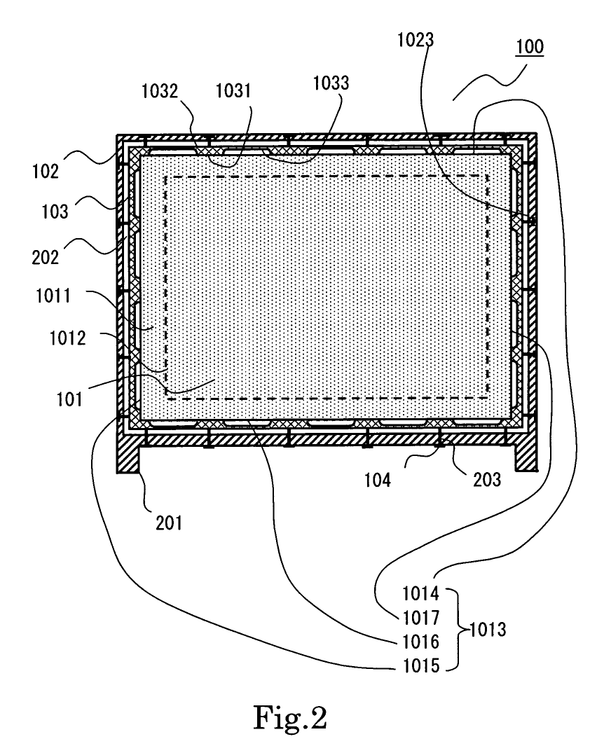

FIG. 2 illustrates a sectional view of the display section 100 in a plane parallel to a display face 1011 of the LCD unit 101. The display section 100 includes the LCD unit 101 as a display unit, the case 102 as a catch member or a housing, a side rubber 103 as an elastic body, and a screw 104 as a press member.

The elastic body such as the side rubber 103 and other rubbers described below may be made from not only rubber but also foamed body such as urethane or other well-known elastic material.

The LCD unit 101 has an outer frame formed with material such as glass or plastics.

The LCD unit 101 has the display face 1011. The LCD unit 101 displays the image, according to the image data from the main body 2, in a displaying area 1012 formed at the front of the LCD unit 101.

Four faces such as a LCD top face 1014, a LCD right side face 1015, an LCD bottom face 1016 and a LCD left side face 1017 (they are collectively called LCD side faces 1013), have a some thickness, and support a pressure from the side rubber 103. The case 102 is a case for protecting the LCD unit 101.

The case 102 covers the side rubber 103 and the display face 1011 except the displaying area 1012. The case 102, as a housing, comprises a hinge joint 201, a LCD housing space 202, and a screw hole 203. The hinge joint 201 rotatably connects with the main body 2. The LCD housing space 202 is formed inside of the case 102. Inside side faces of the case 1023 are inner faces of the LCD housing space 202 facing to the LCD side faces 1013. The LCD housing space 202 houses the LCD unit 101 and the side rubber 103.

The screw hole 203 has a spiral corresponding to the screw 104, and is through the case 102. The screw hole 203 connects the outside of the case 102 and the LCD housing space 202.

The screw hole 203 is formed on each of inside side faces of the case 1023. Each of screw holes 203 is respectively substantially perpendicular to the LCD side faces 1013 in depth. The side rubber 103 has side rubber contact sections 1031 that contacts the LCD side faces 1013. The side rubber 103 also has a side rubber press section 1032 which contacts the screw 104, behind the side rubber contact section 1031.

The screw hole 203 faces the side rubber press section 1032. A thrust of the screw 104 transmits to the side rubber contact section 1031. The side rubber 103 is formed like a frame surrounding the LCD unit 101.

The side rubber 103 is placed in the gap between the LCD unit 101 and inside side faces of the case 1023. The side rubber 103 is provided to cushion a shock given to the LCD unit 101 from the case 102. All the side rubber contact sections 1031 contact the LCD unit 101.

As the result, shaking of the LCD unit 101 can be absorbed, and a stress can be spread to each side rubber contact sections 1031 when an impulse force or shock is added on the case 102.

There is a roll off 1033 between each of side rubber contact sections 1031. The side rubber 103 is deformed along the direction parallel to one of LCD side faces 1013 facing to the roll off 1033 by the thrust of the screw 104. The roll off 1033 is a buffer for the deformation of the side rubber contact section 1031. Accordingly, the side rubber 103 can be deformed. The screw 104 is screwed in the screw hole 203 of the case 102 from the outside of the case 102.

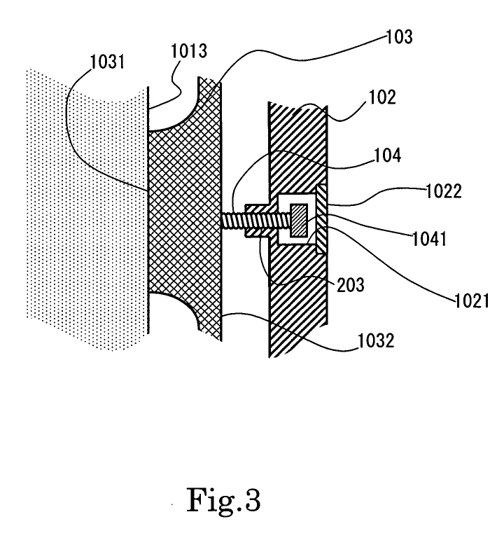

FIG. 3 illustrates a sectional view of a section near the screw hole 203 and the screw 104. The screw head 1041 of the screw 104 is buried into a counter boring 1021 bored at the outside of the case 102. The counter boring 1021 is covered by a seal cover 1022 so that the screw head 1041 cannot be seen from the outside of the case 102.

A tip of the screw 104 contacts the side rubber press section 1032. The tip of the screw 104 screwed in the screw hole 203 presses and deforms the side rubber 103. Accordingly, energy transferred from the case 102 can be absorbed. As a result, bounce is produced between the case 102 and the LCD side faces 1013, and all the side rubber contact sections 1031 contact LCD side faces 1013.

If a screw 104 is directly screwed in the LCD unit 101 to produce a tension between the case 102 and the LCD side faces 1013 for contact of the side rubber 103, when an impulse force is added on the case 102, the screw 104 concentrates and transmits the impulse force that can destroy the LCD unit 101. In contrast, the display section 100 in this exemplary embodiment has such a structure to use the shock absorbing elastic body for supporting the LCD unit 101. Accordingly, the LCD unit 101 can survive being dropped and be protected from the impulse force or shock transmitted from the case 102.

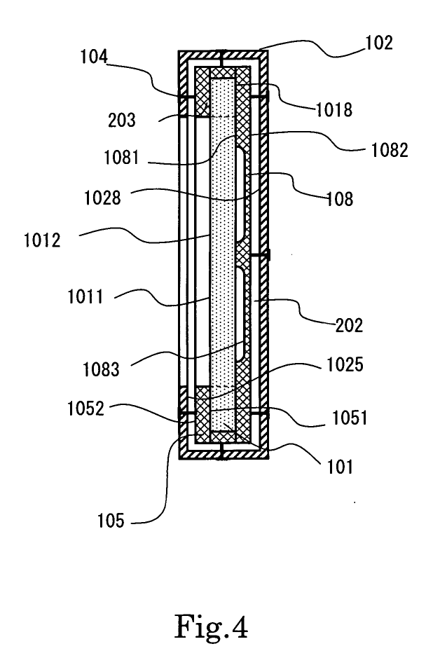

FIG. 4 illustrates a sectional view of a display section 100 in a plane parallel to the LCD left side face 1017 of the LCD unit 101. The case 102 covers the front rubber 105 and the display face 1011 except the displaying area 1012. A portion around the displaying area 1012 on the display face 1011 supports a pressure from a front rubber 105.

A LCD back face 1018 that is behind the display face 1011 supports a pressure from a back rubber 108.

The LCD housing space 202 houses the front rubber 105 and the back rubber 108. An inside front face of the case 1025 is an inner face of the LCD housing space 202 facing to the display face 1011. An inside back face of the case 1028 is an inner face of the LCD housing space 202 facing to the LCD back face 1018. The inside front face of the case 1025 has an opening at a position facing to the displaying area 1012.

The screw hole 203 of the inside front face of the case 1025 is substantially perpendicular to the LCD front face 1025 in depth. A plurality of screw holes 203 are formed in line parallel to four sides of the inside front face of the case 1025.

The screw hole 203 of the inside back face of the case 1028 is substantially perpendicular to the LCD back faces 1018 in depth. A plurality of screw holes 203 are formed in line parallel to four sides of the inside back face of the case 1028. The front rubber 105 is formed to support the display face 1011. The front rubber 105 has an opening at a position facing the displaying area 1012.

The front rubber 105 is placed in the gap between the display face 1011 and the inside front face of the case 1025. The front rubber 105 cushions a shock given to the LCD unit 101 from the case 102.

The front rubber 105 has front rubber contact sections 1051 which contacts the LCD unit 101. All front rubber contact sections 1051 contact the LCD unit 101. As a result, shaking of the LCD unit 101 can be absorbed, and a stress can be well spread to each front rubber contact sections 1051 when an impulse force or shock is added on the case 102. The front rubbers 105 have a front rubber press section 1052 which contacts the screw 104, behind the front rubber contact section 1051. The back rubber 108 is formed to support the LCD back face 1018. The back rubber 108 is placed in the gap between the back face 1018 and the inside back face of the case 1028. The back rubber 108 cushions a shock given to the LCD unit 101 from the case 102. The back rubber 108 has back rubber contact sections 1081 that contacts the LCD unit 101. All back rubber contact sections 1051 contact the LCD unit 101. As the result, shaking of the LCD unit 101 can be absorbed, and stress can be spread to each back rubber contact sections 1081 when an impulse force is added to the case 102. The back rubbers 108 have a back rubber press section 1082 which contacts the screw 104, behind the back rubber contact section 1081. There is a roll off 1083 between back rubber contact sections 1081. The back rubber 108 is deformed along the direction parallel to one of LCD back faces 1018 facing the roll off 1083, by the thrust of the screw 104. The roll off 1083 is a buffer for the deformation of the back rubber contact section 1081. As such, the back rubber 108 can be resiliently deformed.

The tip of the screw 104 screwed in the screw hole 203 of the inside front face of the case 1025 presses and deforms the front rubber 105. As the result, shock is absorbed from the case 102 and all the front rubber contact sections 1051 contact the LCD unit 101. The tip of the screw 104 screwed in the screw hole 203 of the inside back face of the case 1028 presses and deforms the back rubber 108. As the result, bounce is produced between the case 102 and the LCD back face 1018, and all the back rubber contact sections 1081 contact the LCD unit 101.

According to this exemplary embodiment, all contact sections of all rubbers can contact the LCD unit 101, so all rubbers can cushion a shock given to the LCD unit 101 from the case 102. Furthermore, because rigid body contacts the LCD unit 101, shock will not transfer to the LCD unit 101 without being cushioned by rubbers. Accordingly, the effects of shock on the LCD unit 101 can be reduced. Additionally, it is not necessary for rubbers to be compressed greatly when being inserted into the gap between the LCD unit and the case. Accordingly, the display section 100 can be assembled very easily.

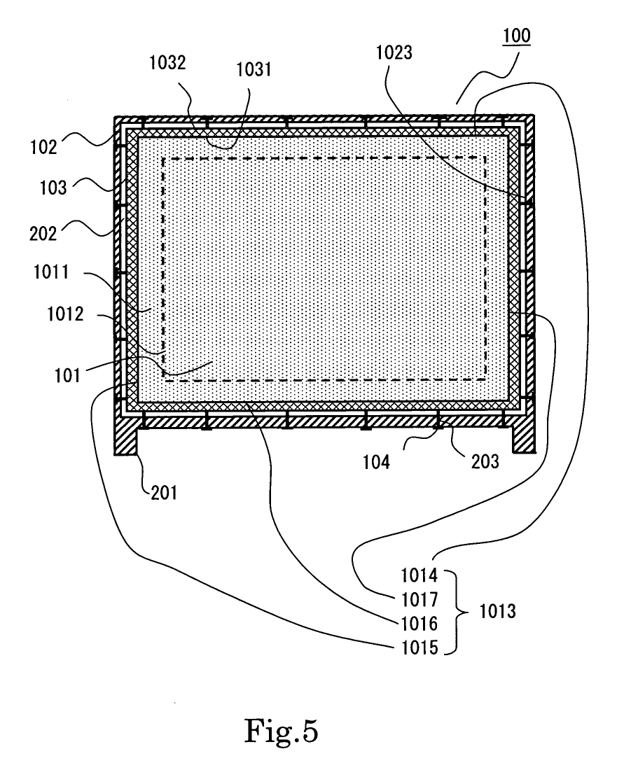

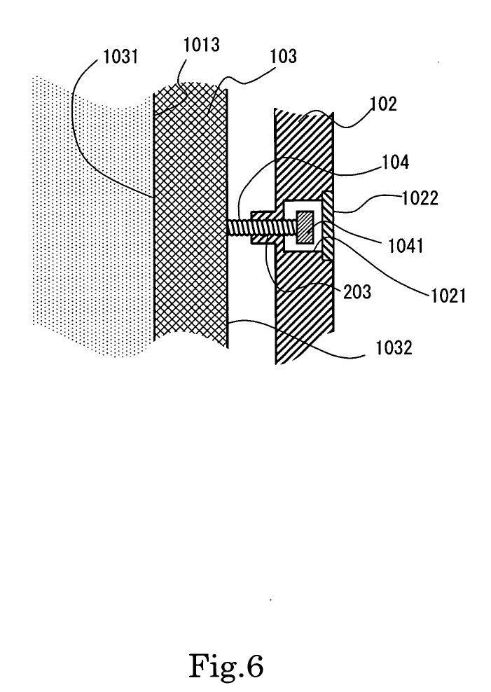

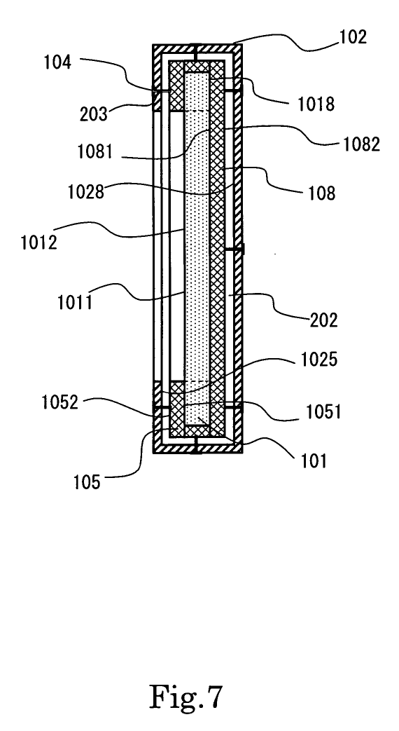

In addition, it is possible to form rubbers without roll offs if elasticity of rubbers can be assumed after compressing rubbers with screws, as shown in FIG. 5, FIG. 6, and FIG. 7.

### Second Exemplary Embodiment

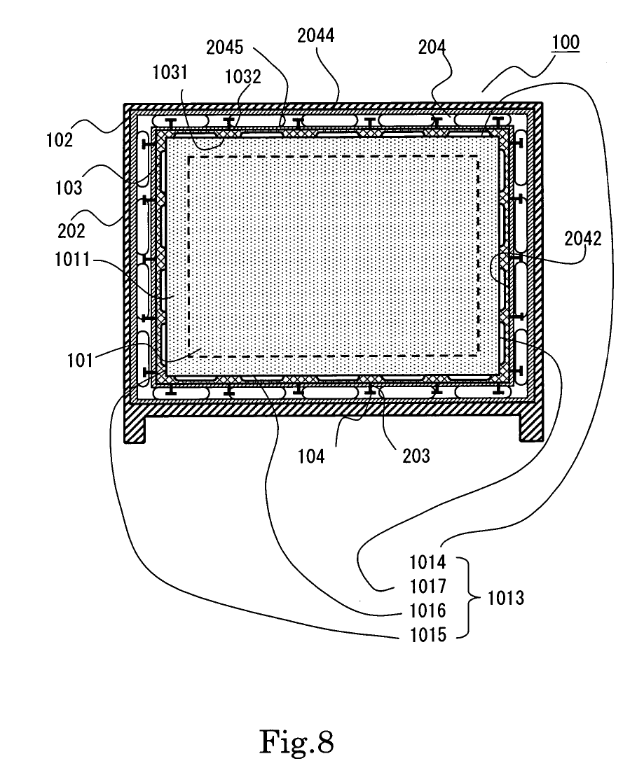

FIG. 8 illustrates a sectional view of the display section 100 in a plane parallel to the display face 1011 of the LCD unit 101 in this exemplary embodiment. In this exemplary embodiment, the case 102 does not have screw holes. But there is a frame 204 as a catch member or a housing, which has screw holes 203, in the LCD housing space 202.

The frame 204 may be made from a light metal, such as a magnesium alloy and an aluminum alloy. The frame 204 has frame outer walls 2044 facing to the LCD housing space 202 of the case 102, and frame inner walls 2045 facing to the LCD unit 101. Frame inner walls 2045 surround a LCD housing space of the frame 2042. The LCD housing space of the frame 2042 houses the LCD unit 101 and the side rubber 103. Frame inner walls 2045 have screw holes 203.

Screw holes 203 have a spiral corresponding to the screw 104, and are through frame inner walls 2045. Screw holes 203 are formed on each of frame inner walls 2045. Each of screw holes 203 are respectively perpendicular to the LCD side faces 1013 in depth. The side rubber 103 has side rubber contact sections 1031 that contacts the LCD side faces 1013. The side rubber 103 also has a side rubber press section 1032 that contacts the screw 104, behind the side rubber contact section 1031.

The screw hole 203 faces the side rubber press section 1032. A thrust of the screw 104 transmits to the side rubber contact section 1031. The side rubber 103 is formed like a frame surrounding the LCD unit 101. The side rubber 103 is placed in the gap between the LCD unit 101 and frame inner walls 2045 surrounding the LCD housing space of the frame 2042. The side rubber 103 cushions a shock given to the LCD unit 101 from the frame 204. All the side rubber contact sections 1031 contact the LCD unit 101. As a result, shock from the shaking of the LCD unit 101 can be absorbed, and stress is well spread to each side rubber contact sections 1031 when an impulse force or shock is added on the case 102 or the frame 204. The screw 104 is screwed in the screw hole 203 of frame outer walls 2044 from the outside of the LCD housing space of the frame 2042.

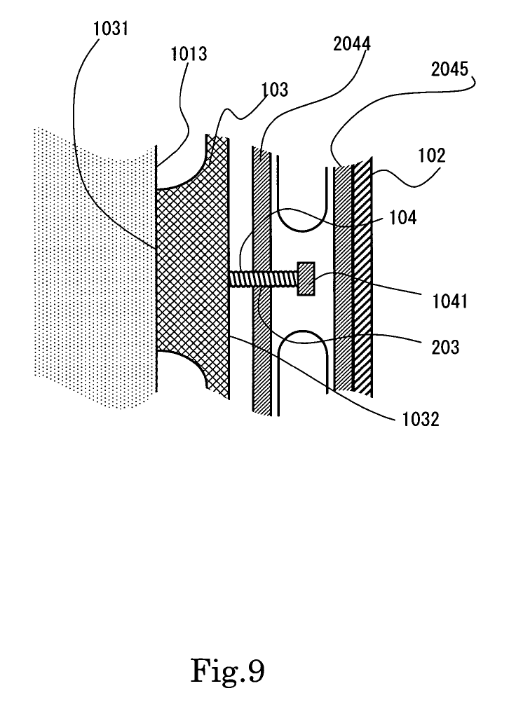

FIG. 9 illustrates a sectional view of a section near the screw hole 203 and the screw 104. The screw head 1041 of the screw 104 is buried into the gap between the frame outer wall 2044 and the frame inner wall 2045, so the screw head 1041 does not protrude from the frame outer wall 2043. A tip of the screw 104 contacts the side rubber press section 1032. The tip of the screw 104 screwed in the screw hole 203 presses and deforms the side rubber 103. As the result, bounce is produced between the case 102 and the LCD side faces 1013, and all the side rubber contact sections 1031 contact LCD side faces 1013. The display section 100 in this exemplary embodiment has such a structure to use the bounce for supporting the LCD unit 101 accordingly, the LCD unit 101 can be protected from the impulse force or shock transmitted from the case 102. In addition, screw holes 203 are not formed on the case 102 but on the frame 204 separate from the case 102. As such, the case 102 can be made safe in a screwing process of the screw 104 and the screw hole 203, because the screwing process can be done far from the case 102 that is often expensive. Moreover, if the screw hole 203 is broken, it is needless to change the case 102.

### Third Exemplary Embodiment

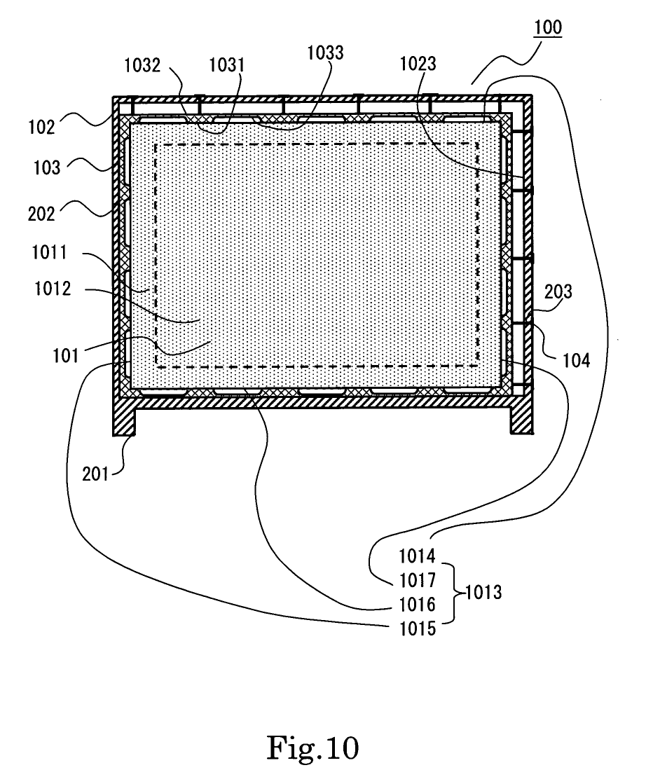

FIG. 10 illustrates a sectional view of the display section 100 in a plane parallel to a display face 1011 of a LCD unit 101 in this exemplary embodiment.

In this exemplary embodiment, screw holes 203 are formed on two faces of inside side faces of the case 1023. One of the faces that the screw hole 203 is formed on is a face facing the LCD top face, and another is a face facing the LCD left side face 1017. The LCD left side face 1017 faces to the screw 104 but the LCD right side face 1015 does not face to the screw 104. The LCD top face 1014 faces the screw 104 but the LCD bottom face 1016 does not face the screw 104. That is, a certain face faces to the screw 104, a face behind the face does not face any screw 204. The screw 104 is screwed in the screw hole 203 of the case 102 from the outside of the case 102.

A tip of the screw 104 contacts the side rubber press section 1032. The tip of the screw 104 screwed in the screw hole 203 presses and deforms the side rubber 103. As the result, bounce is produced between the case 102 and the LCD left side face 1017, and all the side rubber contact sections 1031 contact LCD left side face 1017. The LCD unit 101 which is pushed from the left side presses the side rubber 103 at the other right side. As a result, bounce is produced between the case 102 and the LCD right side face 1015. Also, and all the side rubber contact sections 1031 contact LCD right side face 1015.

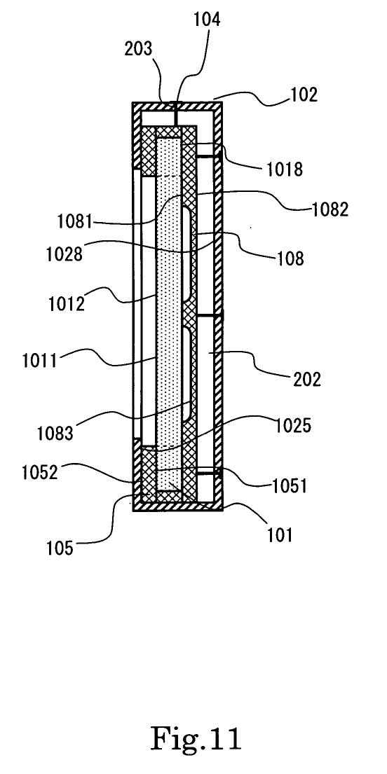

FIG. 11 illustrates a sectional view of the display section 100 in a plane parallel to the LCD left side face 1017 of the LCD unit 101. In this exemplary embodiment, the inside front face of the case 1025 does not have a screw hole 203. The screw hole 203 of the inside back face of the case 1028 is substantially perpendicular to the LCD back face 1018 in depth. A plurality of screw holes 203 are formed in line parallel to four sides of the inside back face of the case 1028. The LCD back face 1018 faces the screw 104 but the display face 1011 does not face the screw 104. That is, a certain face faces the screw 104 and a face behind the face does not face any screw 204. A tip of the screw 104 contacts the back rubber press section 1082. The tip of the screw 104 screwed in the screw hole 203 presses and deforms the back rubber 108. As a result, shock is absorbed and bounce is produced between the case 102 and the LCD back face 1018, and all the back rubber contact sections 1081 contact LCD back face 1018. The LCD unit 101 which is pushed from the back presses the front rubber 105 in the other front. As a result, bounce is produced between the case 102 and the display face 1011 also, and all the front rubber contact sections 1051 contact display face 1011. In this exemplary embodiment, a certain face faces the screw 104 but a face behind the face does not face any screw 204. Accordingly, a relative position of the LCD unit 101 to the case 102 is easily set up. Moreover, structure of the display section 100 can be made simpler.

### Fourth Exemplary Embodiment

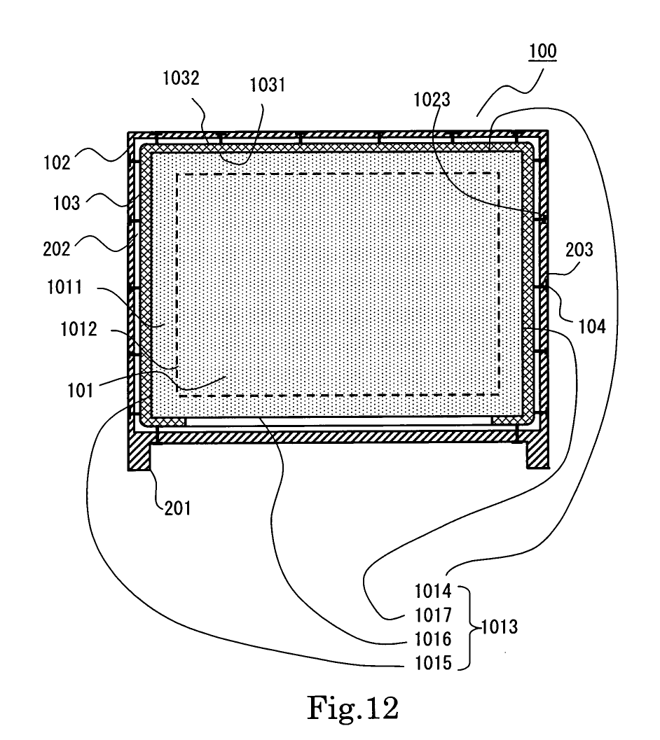

FIG. 12 illustrates a sectional view of the display section 100 in a plane parallel to a display face 1011 of a LCD unit 101 in this exemplary embodiment. In this exemplary embodiment, the side rubber 103 is formed like a bar or a belt. The side rubber 103 is folded in the gap between the LCD unit 101 and inside side faces of the case 1023. Such a bar (or a belt) stile rubber can be produced easily.

The side rubber 103 has a crena or notch at the folded point corresponding to the corner of the LCD unit 101. The side rubber 103 has a length to contact to every LCD side faces 1013. Both ends of the side rubber 103 are located in a gap between the LCD bottom face 1016 and the inside side faces of the case 1023. Wire harnesses can be placed in a void between both ends of the side rubber 103. This void can be used as a roll off for the deformation of the side rubber 103.

Such a bar (or a belt) stile rubber can be used not only as above, but also as a rubber that contacts the display face 1011, the LCD top face 1014, the LCD back face 1018, and the LCD bottom face 1016, and as a rubber that contacts the display face 1011, the LCD left side face 1017, the LCD back face 1018, and the LCD right side face 1015. Each rubber has a length to all every four faces that the rubber contacts respectively.

### Fifth Exemplary Embodiment

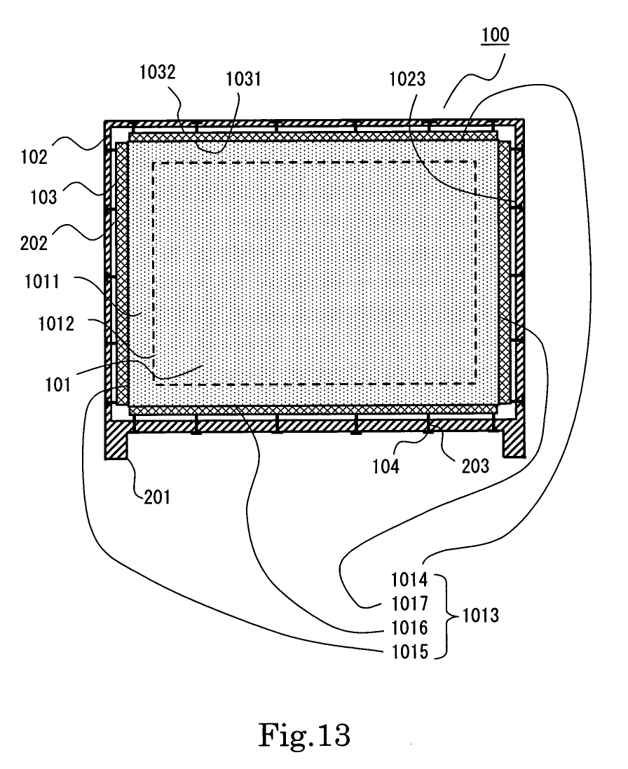

FIG. 13 illustrates a sectional view of the display section 100 in the plane parallel to the display face 1011 of the LCD unit 101 in this exemplary embodiment. In this exemplary embodiment, the side rubber 103 is formed as four bars. Four side rubbers 103 are folded in each gap between edges of the LCD unit 101 and inside side faces of the case 1023, respectively. Such short bar stile rubbers can be produced easily.

Four side rubbers 103 are respectively pushed by screws 104 respectively screwed in screw holes 203 of each of inside side faces of the case 1023. According to this exemplary embodiment, it is easy to form side rubbers 103.

### Sixth Exemplary Embodiment

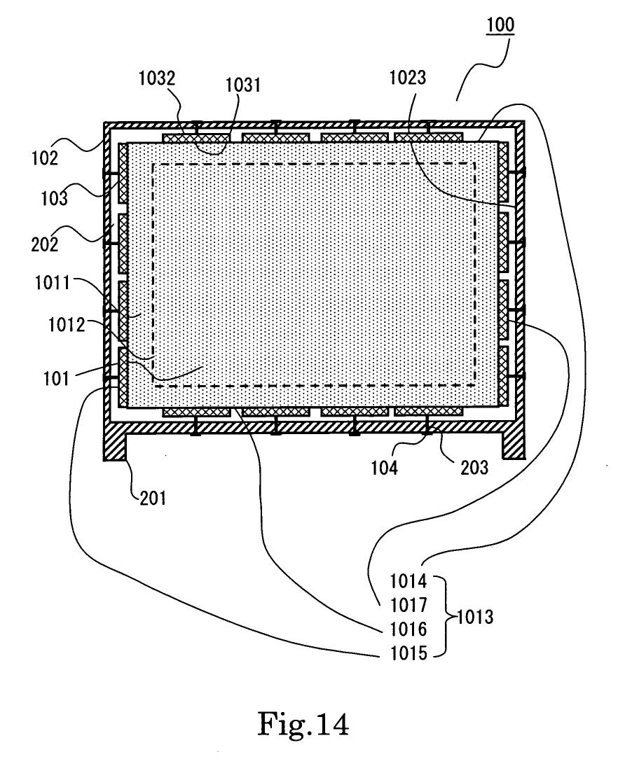

FIG. 14 illustrates a sectional view of the display section 100 in a plane parallel to the display face 1011 of the LCD unit 101 in this exemplary embodiment. In this exemplary embodiment, a total of sixteen side rubbers are used. Four side rubbers 103 are inserted in each four gaps between LCD side faces 1013 and inside side faces of the case 1023.

The screw hole 203 is formed on each of the inside side faces of the case 1023. Each of screw holes 203 are respectively perpendicular to the LCD side faces 1013 in depth. Side rubbers 103 respectively have a side rubber contact section 1031 that contacts one of the LCD side faces 1013. Side rubbers 103 also respectively have a side rubber press section 1032 which contacts the screw 104, behind the side rubber contact section 1031.

The screw hole 203 faces the side rubber press section 1032. A thrust of the screw 104 transmits to the side rubber contact section 1031. The screw 104 is screwed in the screw hole 203 of the case 102 from the outside of the case 102. A tip of the screw 104 contacts the side rubber press section 1032.

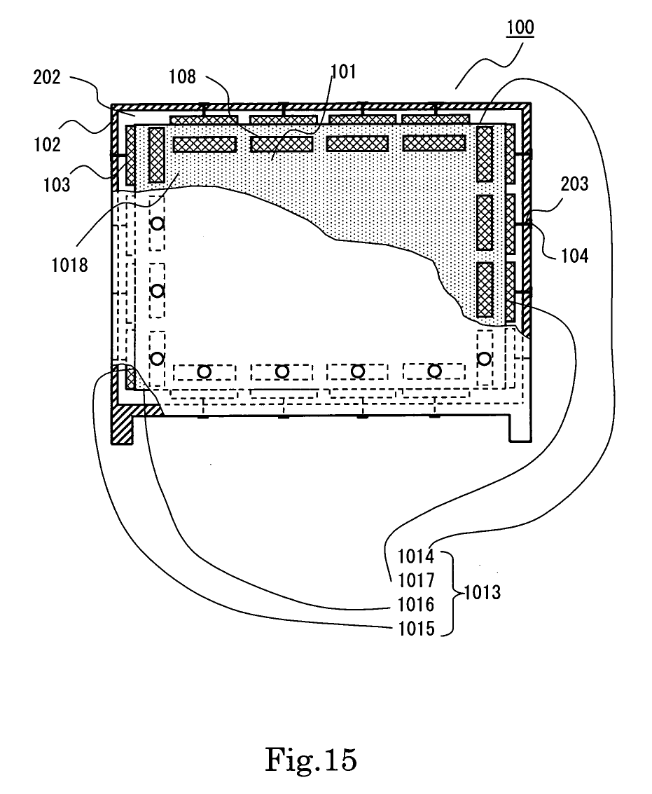

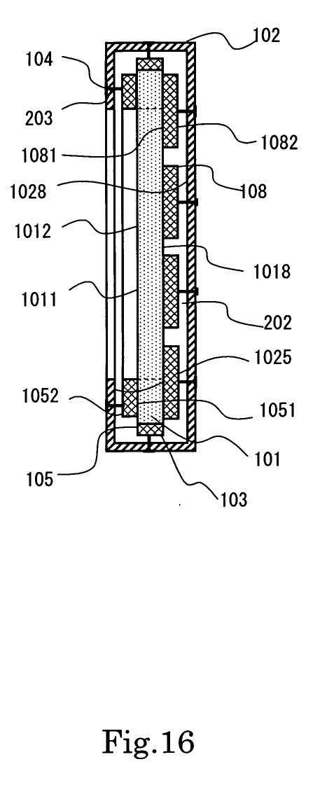

FIG. 15 illustrates a sectional view of the display section 100 in a plane parallel to the display back face 1018 of the LCD unit 101. FIG. 16 illustrates a sectional view of the display section 100 in a plane parallel to the LCD left side face 1017 of the LCD unit 101, in this exemplary embodiment. In this exemplary embodiment, sixteen back rubbers 108 are folded in the gap between the LCD back face 1018 and the inside back face of the case 1028. Four back rubbers 108 are folded around each edge of the LCD back face 1018.

Screw holes 203 are opened on the inside back face of the case 1028. Four screw holes 203 are opened along each edge of the inside back face of the case 1028. Screws 104 are respectively screwed in the screw hole 203 of the case 102 from the outside of the case 102. A tip of the screw 104 contacts the side rubber press section 1032. According to this exemplary embodiment, a plurality of rubbers are folded in the gap between a certain face of the LCD unit 101 and an inside face of the case 102 facing to the certain face of the LCD unit 101, so it is easy to form rubbers.

### Seventh Exemplary Embodiment

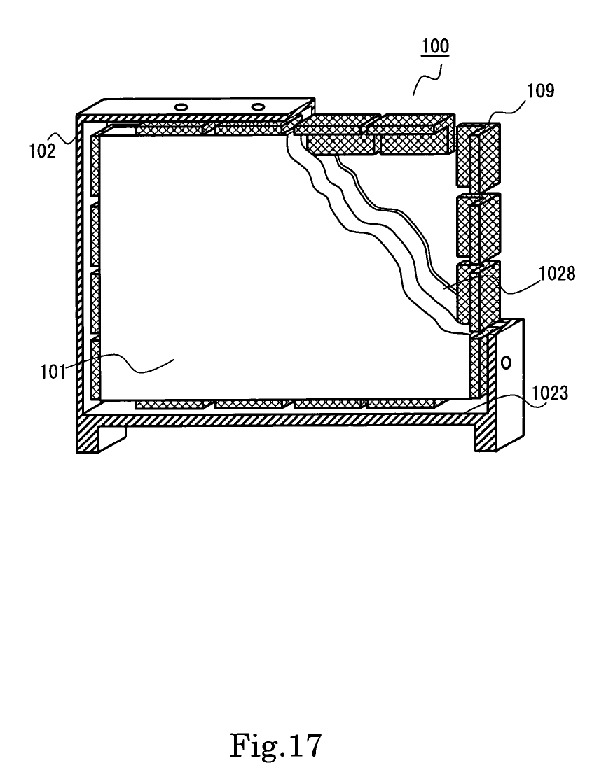

FIG. 17 illustrates a perspective view of angle rubbers 109 in this exemplary embodiment. The angle rubbers 109 are formed like an integration of one of side rubbers 103 and one of back rubbers 108 in the sixth exemplary embodiment. Between the LCD unit 101 and the case 102, angle rubbers 109 are folded instead of the side rubber 103 and the back rubber 108. Angle rubbers 109 are respectively pressed by screws 104 respectively screwed in the screw holes 203 opened on the inside side faces of the case 1023 and inside back face of the case 1028. According to this exemplary embodiment, the number of parts is reduced, and assembly of the display section can be easily performed. In addition, it is possible to form the angle rubber as an integration of one of front rubbers 105 and one of side rubbers 103.

### Eighth Exemplary Embodiment

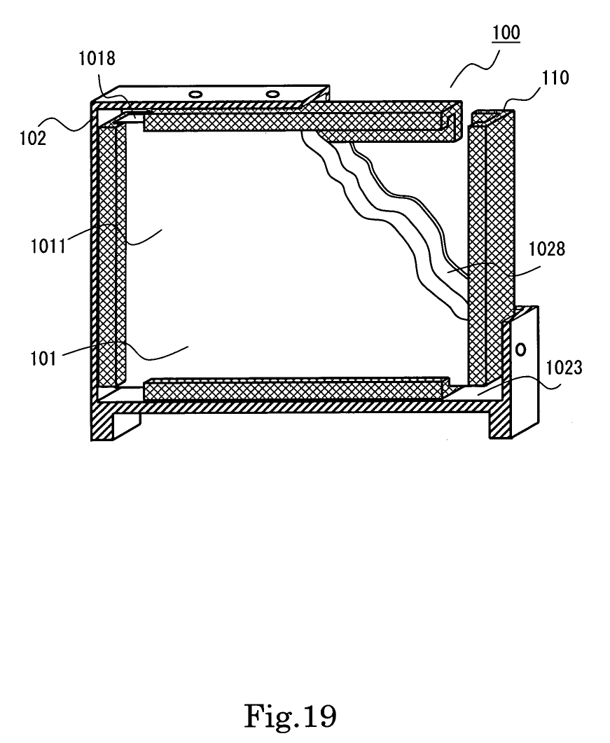

FIG. 19 illustrates a perspective view of the LCD unit 101 and a cushion rubber 110 in this exemplary embodiment. The cushion rubber 110 is formed as a horseshoe shape covering an edge of the display face 1011, the LCD back face 1018, and an edge of the LCD back face 1018. The cushion rubber 110 is placed between the LCD unit 101 and the case 102 instead of the front rubber 105, side rubber 103, and the back rubber 108.

Tips of the screws 104 screwed in screw holes 203 opened on each face of the LCD housing space 202 press and deform the cushion rubber 110. As the result, bounce is produced between the case 102 and the LCD unit 101, and cushion rubber 110 contacts the LCD unit 101. According to this exemplary embodiment, the number of parts is reduced, and assembly of the display section can be easily performed.

### Ninth Exemplary Embodiment

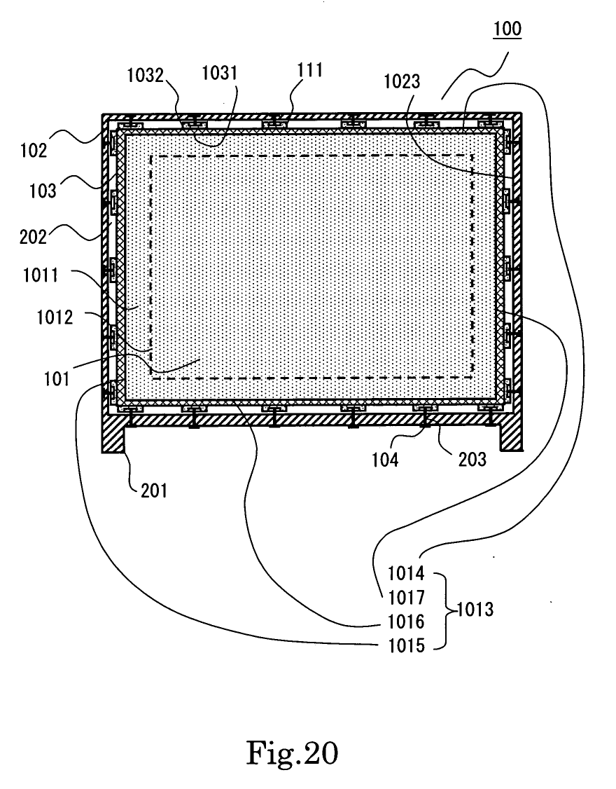

FIG. 20 illustrates a sectional view of the display section 100 in a plane parallel to a display face 1011 of a LCD unit 101 in this exemplary embodiment. In this exemplary embodiment, a pad 111 is placed between the side rubber 103 and the tip of the screw 104. The pad 111 may be made from such metal as stainless steel, aluminum, or any material that can support the pressing force of the screw 104.

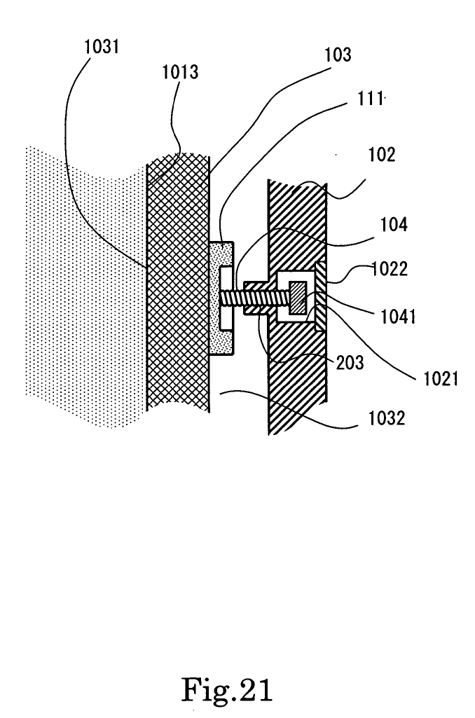

FIG. 21 illustrates a sectional view of a section near the screw hole 203 and the screw 104. A tip of the screw 104 contacts the pad 111, and the pad 111 contacts the side rubber 103. The tip of the screw 104 screwed in the screw hole 203 pushes the pad 111, and the pad 111 presses and deforms the side rubber 103. As the result, bounce is produced between the case 102 and the LCD side faces 1013, and all the side rubber contact sections 1031 contact LCD side faces 1013. The pad 111 scatters the pressing power from the screw 104, and transmits the scattered power to the side rubber 103. As the result, the pressing power from the screw 104 does not concentrate on the side rubber 103, and the side rubber 103 is prevented from damage. In addition, it is possible to prepare the pad 111 not only for the side rubber 103, but also for the other rubbers such as the front rubber 105 and the back rubber 108.

### Tenth Exemplary Embodiment

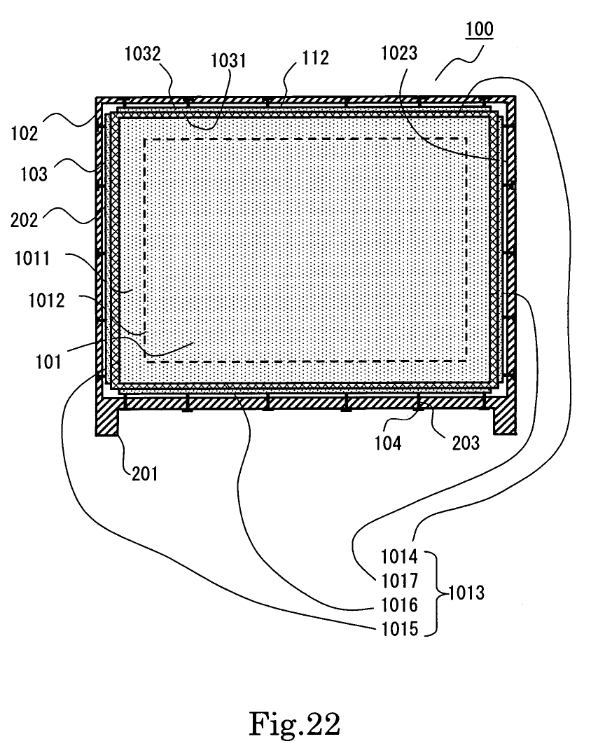

FIG. 22 illustrates a sectional view of the display section 100 in the plane parallel to the display face 1011 of the LCD unit 101 in this exemplary embodiment. A pad 112 is placed in the gap between the side rubber press section 1032 and the inside side faces of the case 1023. The pad 112 has a length almost equal to one of the LCD side faces that the pad is facing.

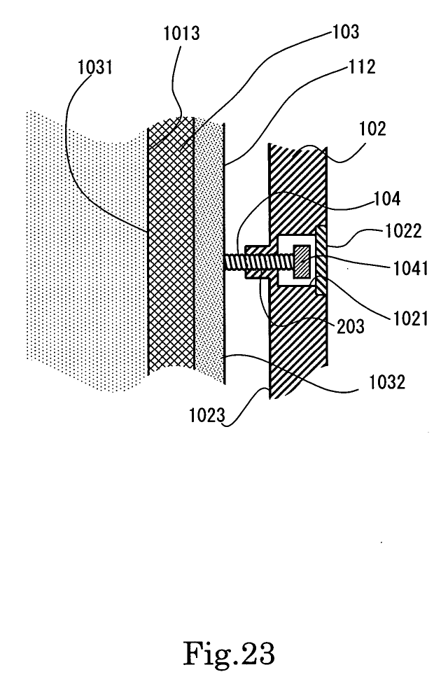

FIG. 23 illustrates a sectional view of a section near the screw hole 203 and the screw 104. A tip of the screw 104 contacts the pad 112. The pad 112 contacts the side rubber press section 1032. The tip of the screw 104 screwed in the screw hole 203 pushes the pad 112, and the pad 112 presses widely and deforms the side rubber 103. As the result, bounce is produced between the case 102 and the LCD side faces 1013, and all the side rubber contact sections 1031 contact LCD side faces 1013. The pad 112 scatters the pressing power from the screw 104, and transmits the scattered power to the side rubber 103. As the result, the pressing power from the screw 104 does not concentrate on the side rubber 103, and thus, the side rubber 103 is prevented from damage. In addition, it is possible to prepare the pad 112 not only for the side rubber 103, but also for the other rubbers such as the front rubber 105 and the back rubber 108.

### Eleventh Exemplary Embodiment

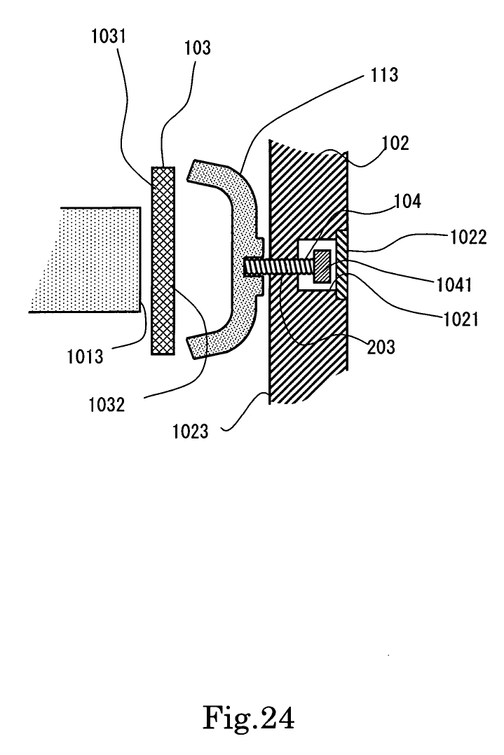

FIG. 24 illustrates a sectional view of the display section 100 in the plane parallel to the LCD side face 1013 of the LCD unit 101 before pressing the side rubber 103 in this exemplary embodiment. The pad 113 that receives the tip of the screw 104 is formed longer than the LCD side face 1013 in the direction perpendicular to the display face 1011. In the direction perpendicular to the display face 1011, both ends of the pad 113 jut from the plane that contacts the side rubber 103. The side rubber 103 is formed like a belt, and side rubber contact section 1031 that is the longer side of the cross section of the side rubber 103 will contact the LCD side face 1013.

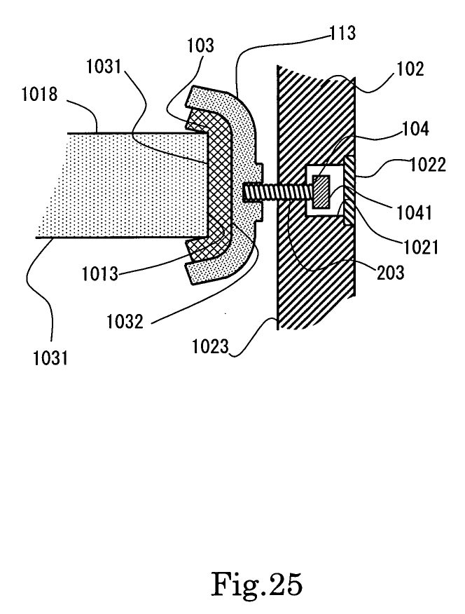

FIG. 25 illustrates a sectional view of the display section 100 in the plane parallel to the LCD side face 1013 of the LCD unit 101 when the pad 113 is pressing the side rubber 103 in this exemplary embodiment. The pad 113 having the jut portion presses and deforms the side rubber 103 along the LCD side face 1013 and the pad 113. The side rubber 103 deforms and clips the edge of the LCD unit 101. As a result, the side rubber 103 can support the LCD unit 101 in the direction perpendicular to the display face 1011 or the LCD back face 1018. Therefore, the number of parts is reduced, and assembly of the display section can be easily performed.

### Twelfth Exemplary Embodiment

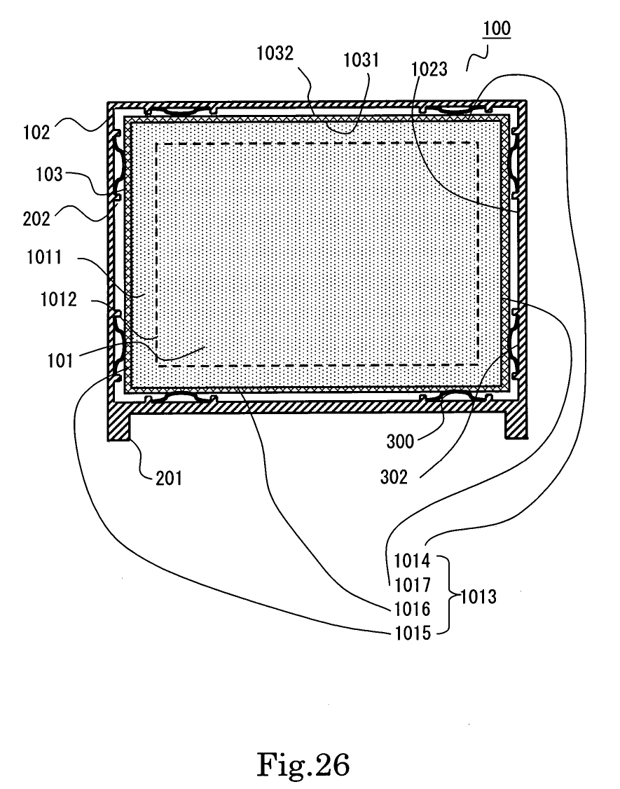

FIG. 26 illustrates a sectional view of the display section 100 in the plane parallel to the display face 1011 of the LCD unit 101 in this exemplary embodiment. In this exemplary embodiment, the display section 100 includes the leaf spring 300 as a press member instead of the screw 104.

The LCD housing space 202 of the display section 100 has plurality of a leaf spring attachments 302 on the inside side face of the case 1023. The leaf spring 300 has enough elastic force to fit the side rubber contact section 1031 of the side rubber 103 to the LCD unit 101. The leaf spring 300 is pressed into the leaf spring attachment 302. The leaf spring 300 has a protruding portion that protrudes from the leaf spring attachment 302. The protruding portion contacts the side rubber press section 1032 and presses the side rubber 103.

A plurality of leaf spring attachments 302 have openings on a side facing the side rubber 103 and the side facing the inside front face of the case 1025.

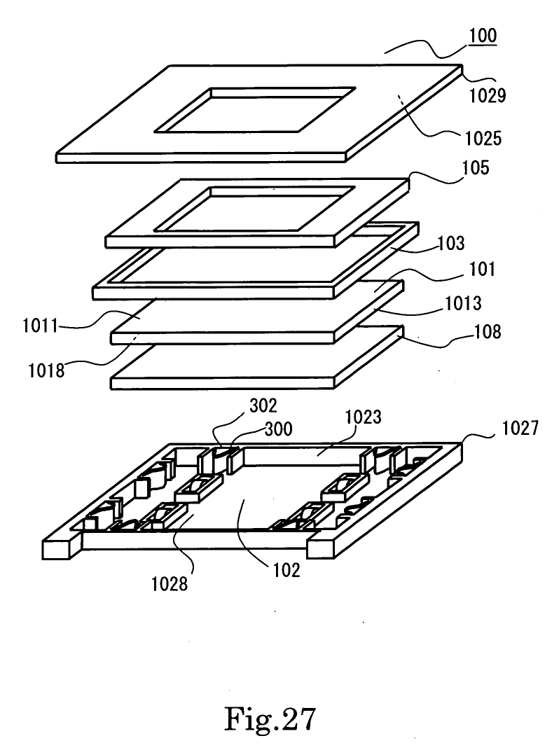

FIG. 27 illustrates a exploded view of the display section 100 in this exemplary embodiment. The case 102 is separately formed as a main body 1027 and a lid 1029. The main body 1027 covers LCD side faces 1013 and LCD back face 1018. The lid 1029 has an opening at a position facing to the displaying area 1012.

Leaf spring attachments 302 are formed in each side of the inside side face of the case 1023. Leaf springs 300 are inserted in each of leaf spring attachments 302. The inside back face of the case 1028 also has a plurality of the leaf spring attachments 302 for storing the leaf spring 300.

The back rubber 108 is put on the leaf spring 300 pressed into the leaf spring attachment 302 of the inside back face of the case 1028. The LCD unit 101 is put on the back rubber 108. The side rubber is inserted into the gap between the LCD unit 101 and the case 102. After that, the leaf spring 300 is pressed into the leaf spring attachment 302 of the inside side face of the case 1023. After pressing the leaf spring 300 into the leaf spring attachment 302 of the inside side face of the case 1023, the front rubber 105 is put on the LCD unit 101. The lid 1029 is put on the front rubber 105, and fixed on the main body 1027.

According to this exemplary embodiment, the spring is used instead of the screw, so it is possible to dispense with the screwing, allowing the display section to be easily assembled. In addition, the leaf spring 300 can be replaced with any elastic body that has enough elasticity and bounce.

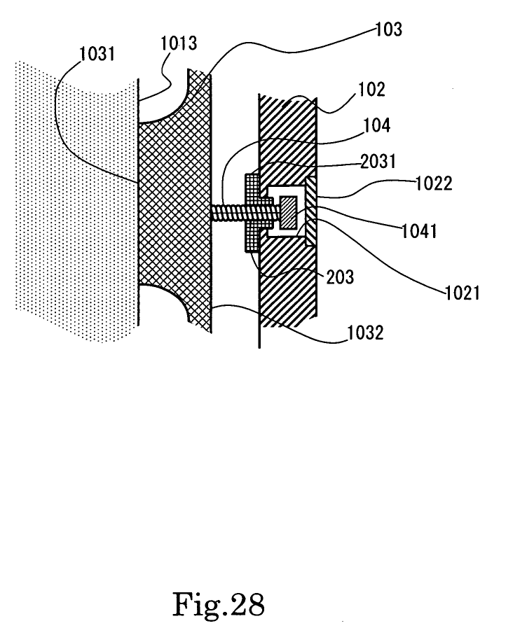

It is described that the screw hole 203 is opened on the case 102 or the frame 204 directly. It is also possible to form the screw hole 203 on another independent member (screw hole member) as shown in FIG. 28. The screw hole member may have a collar. The collar spreads the pressure transmitted the case 102 or the frame 204.

In addition, although the above exemplary embodiments are described about a notebook PC, this invention can be also used in a cellular phone, a clock, a personal digital assistant, or any equipment comprising a display panel such as an LCD. It is therefore to be understood that within the scope of the appended claims, the invention may be practiced otherwise than as specifically described herein.

What is claimed is:

1. A display apparatus, comprising:
a display unit configured to display an image;
a shock absorbing elastic body configured to contact the display unit;
a press member configured to press against the elastic body ; and
a catch member configured to secure the press member;
wherein the elastic body absorbs shock transferred from the catch member to the press member.

2. The display apparatus according to the claim 1, wherein the press member comprises a screw, and the catch member includes a threaded hole in which the screw is inserted.

3. The display apparatus according to the claim 1, wherein the press member comprises a leaf spring.

4. The display apparatus according to the claim 1, wherein the catch member comprises a case which houses the display unit.

5. The display apparatus according to the claim 1, wherein the display unit comprises a first and a second face, said first face does not face a press member and is positioned opposite said second face that faces a press member.

6. The display apparatus according to the claim 1, wherein the display unit comprises plural faces, and the elastic body has a length to contact the plural faces of the display unit.

7. The display apparatus according to the claim 1, wherein the display unit comprises plural faces, the elastic body comprises plural elastic bars each located between one of the faces and the catch member respectively.

8. The display apparatus according to the claim 1, comprising plural elastic bodies placed between a face of the display unit and the catch member.

9. The display apparatus according to the claim 1, wherein the display unit comprises a first face and a second face adjacent to the first face, and the elastic body contacts both the first face and second face.

10. The display apparatus according to the claim 9, wherein the display unit comprises a display face, a back face behind the display face, and a side face adjacent to both the display face and the back face, and the elastic body contacts both the back face and the side face.

11. The display apparatus according to the claim 9, wherein the display unit comprises a display face, a back face opposite the display face, and plural side faces respectively adjacent to both the display face and the back face, and the elastic body contacts the back face and plural side faces.

12. The display apparatus according to the claim 9, wherein the display unit comprises a display face, a back face opposite the display face, and a side face adjacent to both the display face and the back face, and the elastic body contacts the display face, the back face, and the side face.

13. The display apparatus according to the claim 1, further comprising:
a pad located between the elastic body and a respective press member.

14. The display apparatus according to the claim 1, further comprising:
a second press member configured to contact the elastic body;
a pad located between the elastic body and the press members.

15. The display apparatus according to the claim 13, wherein the display unit comprises a side face and a display face, the pad is longer than the side face in a direction perpendicular to the display face, and both ends of the pad in the direction perpendicular to the display face extend from a plane that contacts the elastic body.

16. A display apparatus, comprising:
a display unit configured to display an image;
a housing configured to house the display unit;
a shock absorbing elastic body configured to be placed between the display unit and the housing; and
a press member configured to press against the elastic body.

17. An information terminal, comprising:
a display unit configured to display an image;
a shock absorbing elastic body configured to contact the display unit;
a press member configured to press against the elastic body ; and
a catch member configured to secure the press member;
wherein the elastic body absorbs shock transferred from the catch member to the press member.
